(19) United States
(12) Patent Application Publication
(10) Pub. No.: US 2012/0155496 A1
(43) Pub. Date: Jun. 21, 2012

(54) TESTING DEVICE, TESTING METHOD, AND COMPUTER READABLE STORAGE MEDIUM

(75) Inventors: Takeshi Yasuie, Kawasaki (JP); Yuji Nomura, Kawasaki (JP); Taichi Sugiyama, Kawasaki (JP)

(73) Assignee: FUJITSU LIMITED, Kawasaki-shi (JP)

(21) Appl. No.: 13/230,916

(22) Filed: Sep. 13, 2011

(30) Foreign Application Priority Data
Dec. 17, 2010 (JP) 2010-282437

(51) Int. Cl. H04J 3/06; H04L 12/26

(52) U.S. Cl. 370/503

(57) ABSTRACT

A test information obtaining unit captures an actual transaction from a pre-operation server and stores it in a pre-operation packet storing unit. A time synchronization control section synchronizes the time of a post-operation server with a time of the acquisition times of the captured packets. After performing this time synchronization, a test implementation section performs a test by sequentially transmitting the packets to the post-operation server, thus making responses of the pre-operation server and the post-operation server the same.

### CROSS-REFERENCE TO RELATED APPLICATION

This application is based upon and claims the benefit of priority of the prior Japanese Patent Application No. 2010-282437, filed on Dec. 17, 2010, the entire contents of which are incorporated herein by reference.

### FIELD

The embodiment discussed herein is directed to a testing device, a testing method, and a computer readable storage medium that stores a testing program.

### BACKGROUND

When a devices such as a server performs operations such as applying patches, updating firmware, or updating virus definitions, there is concern as to whether the server operates in a similar way before and after the operations are performed. Specifically, there is concern about the effect of regression of the server's functions or performance.

There is a known telegram message recording apparatus that can perform reproduction tests of occurrence of failures by reproducing transmissions of data at the same intervals as actual transmission intervals and can perform high speed transmission at short telegram message intervals for a part that does not need accurate reproduction to perform simulations effectively. Such an apparatus can perform an accelerated test by accelerating the system time of the apparatus, in which data obtained at short intervals is transmitted at high speed.

Patent Document 1: Japanese Laid-open Patent Publication No. 2010-081194

Patent Document 2: Japanese Laid-open Patent Publication No. 2004-038350

However, data related to the time, such as the validity period, flows during a transaction. Because, in general, there is a time lag between the acquisition time of transaction data and the execution time of operation check, the operation check may not be accurately performed due to, for example, the expiration of the validity period.

An example case is illustrated in FIG. 12 in which the same test is not performed on a server before and after an operation. In this example, by using the actual transaction data obtained during a transaction performed on July 11 between a client and a server before an operation, a test is performed one month later on August 11 between a verification device and the server after the operation. In this case, because the validity period of data requested by the client is set on July 16, a normal response is returned from the pre-operation server at the time of the actual transaction. However, because the validity period expires at the time of the test, an abnormal response is returned from the post-operation server. Accordingly, it is not possible to allow the server to behave at the time of the test performed on August 11 as it did at the time of the actual transaction performed on July 11; therefore, an accurate operation test is not performed. As described above, there is a problem in that a transaction test related to, for example, a validity period may not be performed.

### SUMMARY

According to an aspect of an embodiment of the invention, a testing device includes a testing unit that transmits collected packets to a target device in order of collection times and obtains a response to the transmitted packets to perform a test, and a synchronization control unit that synchronizes a time of the target device with a time of the packet collection times.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a schematic diagram illustrating the configuration of a testing device according to an embodiment of the present invention;

FIG. 2 is a block diagram illustrating the hardware configuration of the embodiment of the present invention;

FIG. 3 is a flowchart illustrating the flow of a packet obtaining process;

FIG. 4 is a flowchart illustrating the flow of a process performed by a test implementation unit;

FIG. 5 is a schematic diagram illustrating test operations when time synchronization is performed;

FIG. 6 is a schematic diagram illustrating a specific example of test operations;

FIG. 7 is a schematic diagram illustrating a specific example of operations when polling-type time synchronization is used;

FIG. 8 is a flowchart illustrating the flow of a polling-type process performed by the test implementation unit;

FIG. 9 is a schematic diagram illustrating information used for managing the associated relationship between pre-operation servers and post-operation servers when a plurality of servers to be tested is arranged;

FIGS. 10A and 10B are schematic diagrams illustrating information used for managing time synchronization targets;

FIG. 11 is a schematic diagram illustrating packet capture information; and

FIG. 12 is a schematic diagram illustrating a specific example of a case in which the same test is not performed on a server before and after an operation.

### DESCRIPTION OF EMBODIMENT

A preferred embodiment of the present invention will be explained with reference to accompanying drawings.

The present invention is not limited to the embodiment.

### Embodiment

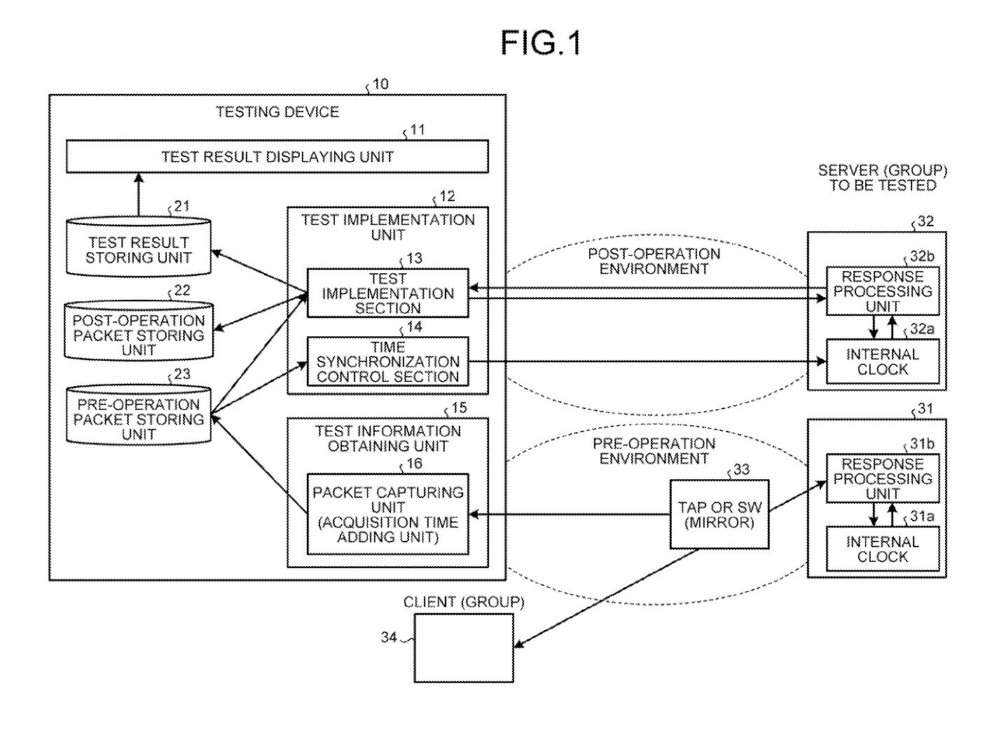

FIG. 1 is a schematic diagram illustrating the configuration of a testing device 10 according to an embodiment of the present invention. The testing device 10 includes a test result displaying unit 11, a test implementation unit 12, a test information obtaining unit 15, a test result storing unit 21, a post-operation packet storing unit 22, and a pre-operation packet storing unit 23.

The testing device 10 is connected to a server 31 and a client 34 via a switch 33. The server 31 is a device that obtains a packet. For example, the server 31 is a server to which a patch is not applied, a server in which firmware is not updated, or a server in which virus definitions are not updated. Similarly, the testing device 10 is also connected to a server 32. The server 32 is a device to be tested. For example, the server 32 is a server to which a patch is applied, a server in which firmware is updated, or a server in which virus definitions are updated. The server 31 and the server 32 can be the same server or can be different servers. In the following description, a description will be given with the assumption that the server 31 and the server 32 are different. It is assumed that the server 32 is in a situation where a patch is applied to the server 31. The server 32 is referred to as a post-operation server and the server 31 is referred to as a pre-operation server.

The server 31 includes an internal clock 31a and a response processing unit 31b. The response processing unit 31b processes a request of the client 34 and responds to the client 34. At this time, the response processing unit 31b performs the process by referring to the time indicated by the internal clock 31a.

Similarly, the server 32 includes an internal clock 32a and a response processing unit 32b. The response processing unit 32b processes a request of the testing device 10 and responds to the testing device 10. At this time, the response processing unit 32b performs the process by referring to the time indicated by the internal clock 32a . Furthermore, the internal clock 32a is synchronized by a time synchronization control section 14 included in the testing device 10. Specifically, the response processing unit 32b processes a request by referring to the time that is synchronized by the testing device 10.

The test information obtaining unit 15 includes a packet capturing unit 16 that captures, together with the acquisition times, packets of actual transactions transferred between the one or more clients 34 and the one or more pre-operation servers 31. The packet capturing unit 16 obtains packets from the switch 33 arranged between the client 34 and the server 31.

The test implementation unit 12 includes the time synchronization control section 14 and a test implementation section 13. The time synchronization control section 14 synchronizes the time or the times of the one or more post-operation servers 32 with the capture acquisition time of the actual transaction. The test implementation section 13 converts actual transaction data according to circumstances and transmits the converted data to the post-operation servers 32 to perform a test.

The pre-operation packet storing unit 23 stores therein a capture result for the pre-operation server 31. The post-operation packet storing unit 22 stores therein a capture result for the post-operation server 32. The test result storing unit 21 stores therein the test result and the test result displaying unit 11 displays the test result. Specifically, the test implementation section 13 transmits packets extracted from the pre-operation packet storing unit 23 to the post-operation server 32 and stores a response thereof in the post-operation packet storing unit 22. Then, the test implementation section 13 compares the content stored in the post-operation packet storing unit 22 with the content stored in the pre-operation packet storing unit 23, and stores the comparison result in the test result storing unit 21 or outputs the comparison result to the test result displaying unit 11. In this case, the test result storing unit 21 or the test result displaying unit 11 may be omitted form the configuration.

In the example illustrated in FIG. 1, the test information obtaining unit 15 is arranged in the testing device 10; however, the test information obtaining unit 15 may be separated from the testing device 10.

Because time synchronization is performed at least once in the testing device 10 illustrated in FIG. 1, a test can be accurately performed on a transaction in which the time, such as the validity period, is referred to by a server during a response.

Specifically, to check the operations of the pre-operation server and the post-operation server at the same time (under the same condition), the testing device 10 synchronizes (puts back the time) the time of the post-operation server with the acquisition time of the actual transaction of the pre-operation server and checks the operations. At this time, the synchronization is preferably performed periodically or at the times (T1-ΔT, T2-ΔT) obtained by subtracting a predetermined time (ΔT) from times (T1, T2) at which packets for time reference are transmitted, and then the operations are checked. The time of the server is, for example, the time indicated by the internal clock 32a that is referred to by the response processing unit 32b of the server 32 when the response processing unit 32b performs the process. When data having a validity period is requested, the time indicated by the internal clock 32a is used to determine whether the validity period is valid.

In particular, an accelerated test in which an operation test for one-month data is performed in two days needs to sequentially accelerate a clock; therefore, the test needs to sequentially adjust a time in addition to the time adjustment at the start time of the operation check. However, because a validity period is usually set in unit of months and hours, a detailed time adjustment in unit of minutes or below is sometimes not needed. In such a case, the frequency of the time adjustment is adjusted in accordance with the duration of the validity period.

In the adjustment method, an actual transaction between the client and the pre-operation server is captured and simultaneously the acquisition time thereof is recorded. When performing a test, the test is performed by steps of:
(1) synchronizing the time of the post-operation server with the acquisition time of the actual transaction; and
(2) transmitting actual transaction data to the post-operation server to check an operation of the post-operation server. The time synchronization (1) can be performed for each packet. The determination of whether the time synchronization is performed for each packet can be also performed on the basis of the duration of the validity period or the like. For example, if the duration of the validity period is one hour, there is also a method for performing the time synchronization (1) under the condition that the difference between the acquisition time and the synchronization time is greater than one hour. The duration can be previously set or can be obtained by learning from the actual transaction data.

When performing such time synchronization, it is preferable that a push-type time synchronization is performed from the testing device 10 to the post-operation server. The target post-operation server is previously registered in the testing device; the synchronization time is transmitted from the testing device to the post-operation server; and the time is set for the post-operation server. Alternatively, the testing device remotely enters the post-operation server to set the synchronization time. Furthermore, a user can manually perform the synchronization.

A standard network time protocol (NTP) or simple network time protocol (SNTP) can also be used as the method for performing the time synchronization. These protocols are polling-type protocols in which a client obtains the synchronization time from the server in the client/server configuration. Accordingly, it is also possible to adjust the time synchronization by setting an NTP client as the post-operation server and an NTP server as the testing device and by changing the processing period of the time synchronization performed by the post-operation server.

Even in a case in which several devices cooperatively function as the post-operation servers, a test is possible by performing the time synchronization on all of the cooperating post-operation servers.

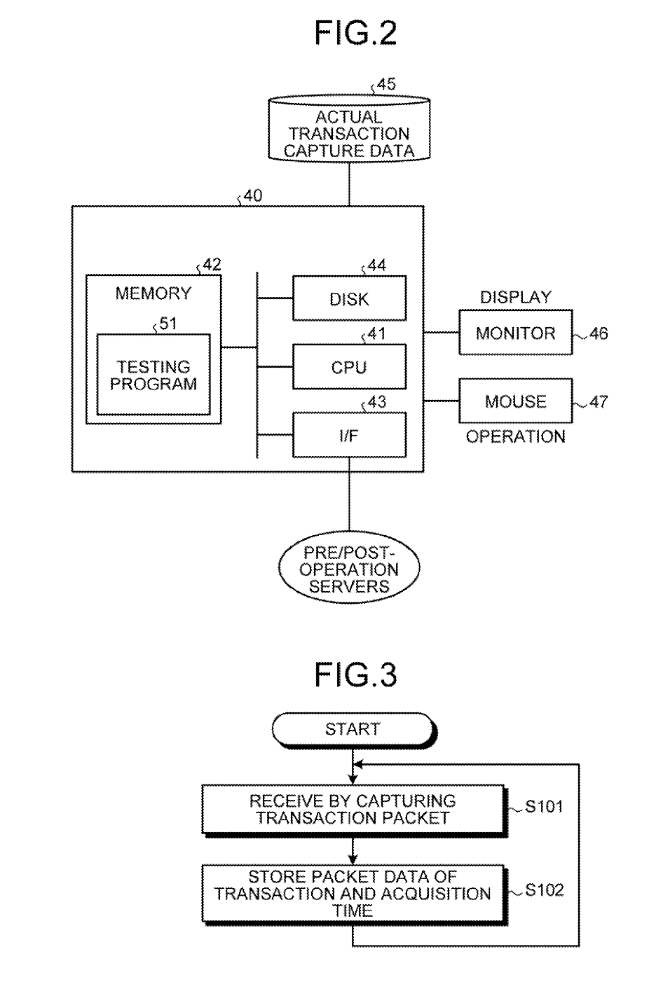

FIG. 2 is a block diagram illustrating the hardware configuration of the embodiment of the present invention. A computer 40 includes a central processing unit (CPU) 41, a memory 42, an interface (I/F) 43, and a disk 44. Each of the components are connected to each other via a bus. The CPU 41 performs the overall control on the computer 40. The memory 42 is used as a work area of the CPU 41 and a testing program 51 operates in the memory 42. A monitor 46 is externally arranged and displays a cursor, icons, tool boxes, and data such as documents, images, and function information, which are operated by using a mouse 47. For example, a CRT display, a TFT liquid crystal display, or a plasma display can be used for the monitor 46. The I/F 43 is connected to a network, such as a local area network (LAN), a wide area network (WAN), and the Internet, via a communication line and is further connected to other devices including the pre-operation server and the post-operation server via the network. Furthermore, the I/F 43 manages the network and an internal interface and controls the input/output of data input from and output to an external unit. For example, a LAN adaptor or a modem can be used for the I/F 43.

FIG. 3 is a flowchart illustrating the flow of a packet obtaining process. The packet capturing unit 16 repeats a process for receiving packets of a transaction from the switch 33 (Step S101) and storing the packets of the transaction and the acquisition times in the pre-operation packet storing unit 23 (Step S102).

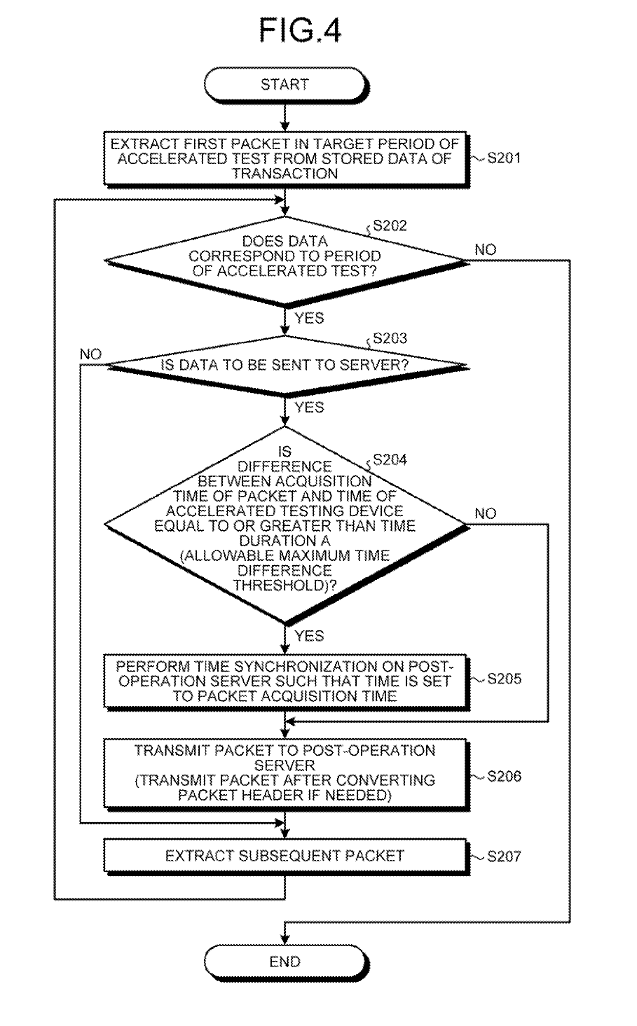

FIG. 4 is a flowchart illustrating the flow of a process performed by the test implementation unit 12. The test implementation unit 12 extracts, from the transaction data stored in the pre-operation packet storing unit 23, a first packet in the target period of the accelerated test (Step S201). The test implementation unit 12 refers to the time of the extracted packet. If the packet data is not the data in the testing period (No at Step S202), the test implementation unit 12 ends the process.

If the extracted packet is the packet data in the testing period (Yes at S202), the test implementation unit 12 determines whether the extracted packet is a packet that is to be sent to the server (Step S203).

If the packet is a packet to be sent to the server (Yes at Step S203), the test implementation unit 12 determines whether the difference between the acquisition time of the packet and the time of the testing device 10 exceeds a predetermined time duration, i.e., an allowable maximum time difference threshold (Step S204).

If the difference between the acquisition time of the packet and the time of the testing device 10 exceeds the predetermined time duration (Yes at Step S204), the test implementation unit 12 performs the time synchronization on the server group in such a manner that the time of the server group is set to the packet acquisition time (Step S205).

When the time synchronization is completed at Step S205 or when the difference between the packet acquisition time and the time of the testing device 10 is equal to or less than the predetermined time duration (No at Step S204), the test implementation unit 12 transmits the extracted packet to the post-operation server (Step S206). At this time, when packet information is changed, for example, when the post-operation server is different from the pre-operation server, a part of the packet, such as a packet header, is rewritten and is transmitted. Rewriting of the packet header will be described later.

When the packet has been transmitted at Step S206 or when the extracted packet is not a packet to be sent to the server (No at Step S203), the test implementation unit 12 extracts the subsequent packet (Step S207) and repeats the process of Steps S202 to S207.

According to the flow of the above process, one or more time synchronizations are performed on the post-operation server in accordance with the packet acquisition times of the packets in the accelerated test period from among the packets of the transaction, and then the packets are converted and transmitted to the post-operation server.

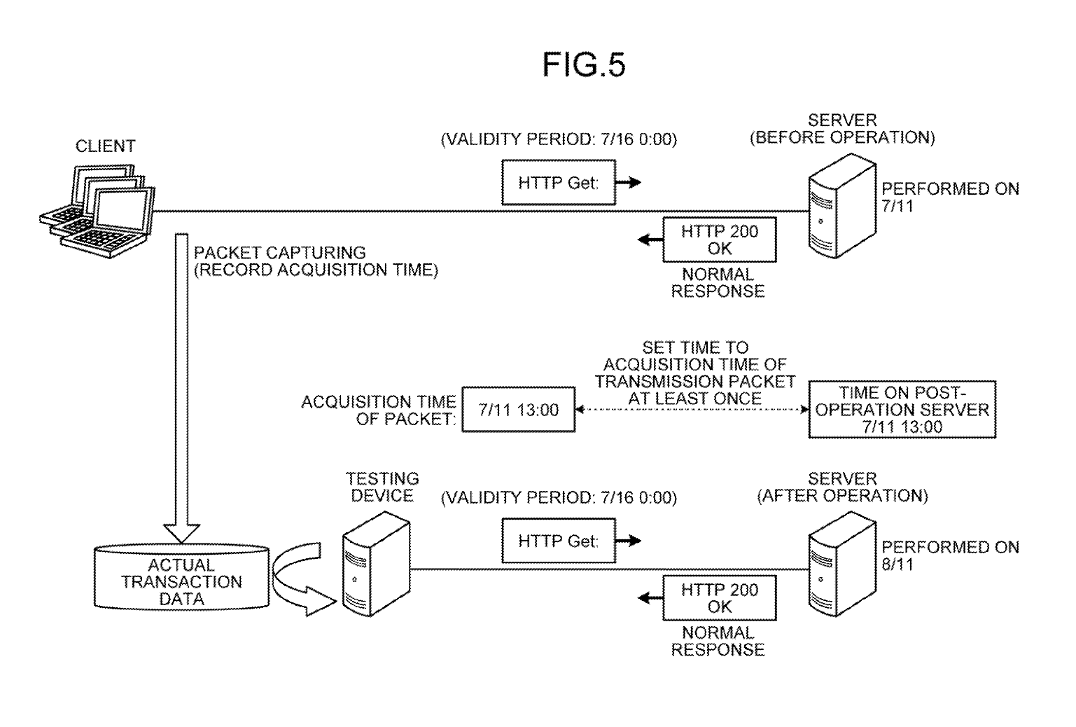

FIG. 5 is a schematic diagram illustrating test operations when time synchronization is performed. In the example illustrated in FIG. 5, by using the actual transaction data obtained by performing transactions between clients and the pre-operation server on July 11, a test is performed one month later on August 11 between the testing device 10 and the post-operation server. In this case, because the validity period of data requested by a client is set to July 16, a normal response is returned from the pre-operation server at the time of the actual transaction.

Furthermore, because the time of the post-operation server is synchronized with the acquisition times of the transmission packets one or more times at the time of testing, the validity period becomes valid even when testing is performed on the post-operation server. Accordingly, the post-operation server returns the same normal response as that of the case where the packets are acquired on July 11. Specifically, the post-operation server can behave on August 11 as it did at the time of the actual transaction performed on July 11; therefore, the operation test can be accurately performed.

In the embodiment, a description will be given with the assumption that, in an HTTP communication, the validity period is set and notified from a Set-Cookie header in an HTTP header on the server side; however, the present invention is not limited thereto.

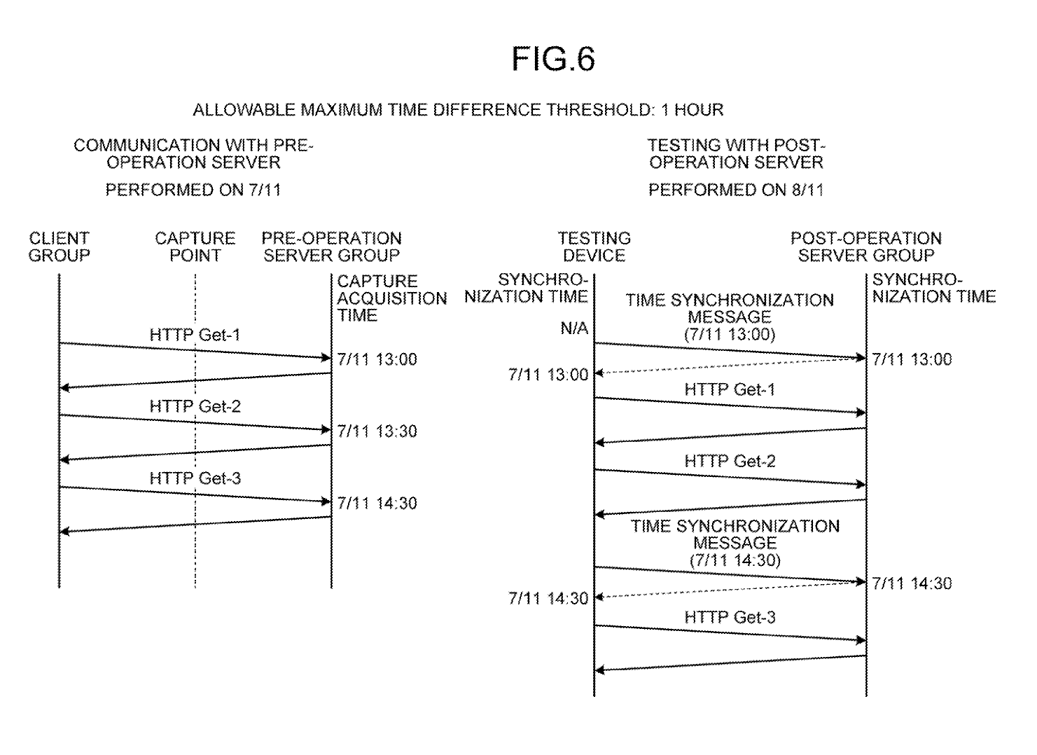

FIG. 6 is a schematic diagram illustrating a specific example of test operations. In the example illustrated in FIG. 6, it is assumed that an allowable maximum time difference threshold is set to one hour as a threshold for determining whether the time synchronization is performed first. The value of one hour is set by taking into consideration, for example, the minimum validity period. As illustrated in the left portion of FIG. 6, in the communication with the pre-operation server, it is assumed that HTTP Get-1, HTTP Get-2, and HTTP Get-3 are data that are respectively acquired at 13:00 on July 11, at 13:30 on July 11, and at 14:30 on July 11. In such a case, these three request packets are converted and then transmitted to the post-operation server when the test is performed on the post-operation server illustrated in the right portion of FIG. 6.

In this process, HTTP Get-1 is the first packet for the test and thus the time synchronization is not performed. Accordingly, a time synchronization message of 13:00 on July 11, which is the acquisition time of the request packet, is first sent to the post-operation server group, and then the time synchronization is performed. After that, HTTP Get-1 is converted and transmitted to the post-operation server group.

Then, the previous time synchronization time is 13:00 on July 11 and the acquisition time of the request packet for HTTP Get-2 is 13:30 on July 11. In this case, because the time difference between 13:00 and 13:30 is smaller than the allowable maximum time difference threshold (one hour), HTTP Get-2 is converted and transmitted to the post-operation server group without performing the time synchronization thereon.

On the other hand, the previous time synchronization time is 13:00 on July 11 and the acquisition time of the request packet for HTTP Get-3 is 14:30 on July 11. In this case, because the time difference between 13:00 and 14:30 is larger than the allowable maximum time difference threshold (one hour), a time synchronization message of 14:30 on July 11, which is the acquisition time of the request packet, is first transmitted to the post-operation server group and the time synchronization is performed, and then HTTP Get-3 is converted and transmitted to the post-operation server group.

When the packet is converted, the IP address is needed to be converted if an IP address of the pre-operation server is different from that of the post-operation server. Meanwhile, even when the IP addresses are the same, a sequence number of TCP and information unique to the server (e.g., cookie header information for identifying a session) in the HTTP header can be converted.

In the explanation described above, an example case has been described in which a push-type time synchronization is used; however, as described above, it is also possible to employ the polling-type time synchronization using NTP.

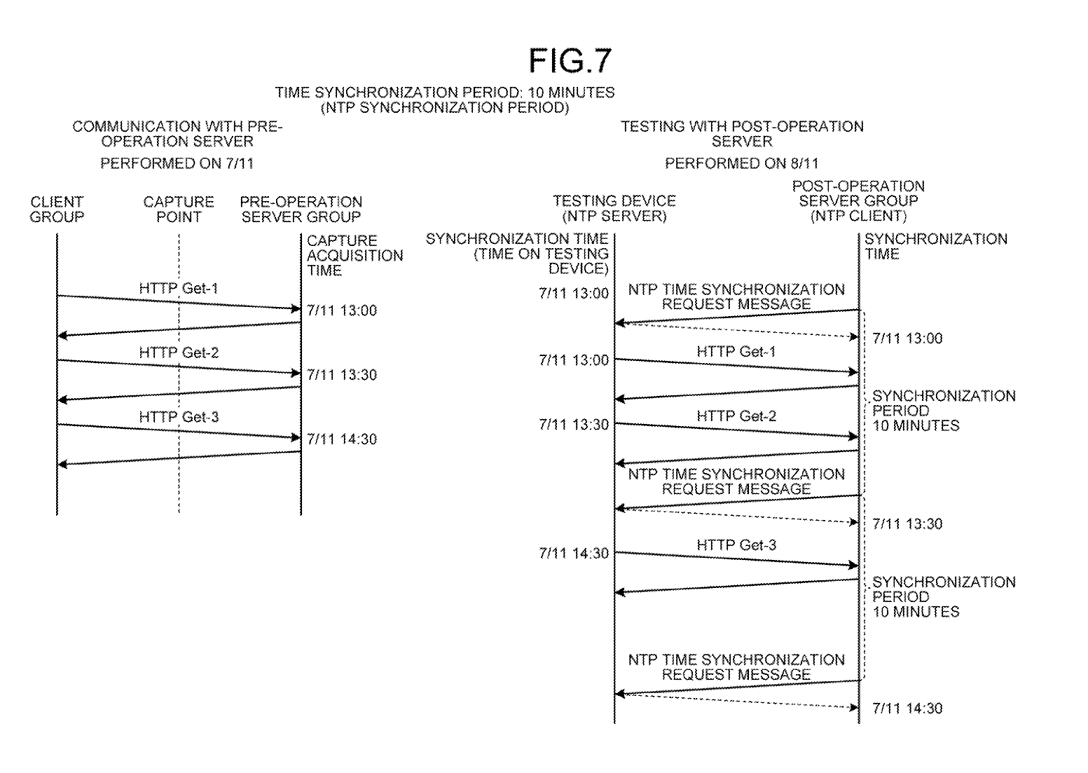

FIG. 7 is a schematic diagram illustrating a specific example of operations when polling-type time synchronization is used. It is assumed that the time synchronization period (NTP synchronization period) of the post-operation server group is previously set to 10 minutes. The period of 10 minutes is set by taking into consideration the minimum validity period, intervals between test packet transmissions, or the like. In the communication with the pre-operation server illustrated in the left portion of FIG. 7, HTTP Get-1, HTTP Get-2, and HTTP Get-3 are captured at 13:00, 13:30, and 14:30 on July 11, respectively. These three request packets are converted to a packet for the post-operation server when the test is performed with the post-operation server illustrated in the right portion of FIG. 7 and are transmitted thereto.

In this process, before transmitting a first packet (HTTP Get-1) of the test, the synchronization time (the time of the testing device) is previously set to the time (at 13:00 on July 11) of the first packet.

Then, NTP time synchronization request messages are received from post-operation server groups, and information (13:00 on July 11) that is set to the synchronization time is synchronized with the time of each of the post-operation server groups.

After receiving the first NTP time synchronization request message, each of the transmission target messages (HTTP Get-1, HTTP Get-2, and HTTP Get-3) are converted to the post-operation server groups and transmitted. However, the synchronization time (the time of the testing device) is set to the message (packet) acquisition time before the transmission, and then the transmission target messages are transmitted to each of the post-operation server groups.

In this example, 10 minutes have elapsed between the HTTP Get-2 transmission and the HTTP Get-3 transmission as the time synchronization period in each of the post-operation server groups. Accordingly, each of the transmission target messages are transmitted after receiving the NTP time synchronization request messages from each of the post-operation server groups; after synchronizing information (the time of HTTP Get-2: 13:30 on July 11), which is set to the synchronization time, with the time of each of the post-operation server groups; and after converting HTTP Get-3.

When the packets are converted, in a similar manner as in the example of the push type, if an IP address of the pre-operation server is different from that of the post-operation server, the IP addresses are needed to be converted. Furthermore, even when IP addresses are the same, a sequence number of the TCP or information (e.g., cookie header information for identifying a session) in the HTTP header unique to the server is converted.

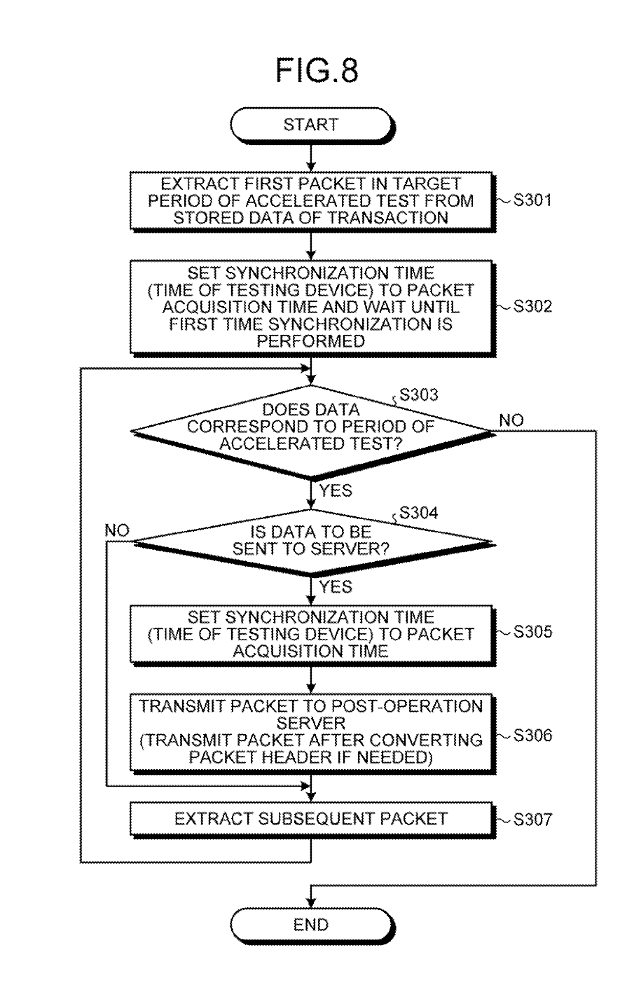

FIG. 8 is a flowchart illustrating the flow of a polling-type process performed by the test implementation unit 12. The test implementation unit 12 extracts, from transaction data stored in the pre-operation packet storing unit 23, a first packet in the target period of the accelerated test (Step S301).

Then, the test implementation unit 12 sets the synchronization time (the time of the testing device 10) to the acquisition time of the packet and waits until a first time synchronization is performed (Step S302).

Thereafter, the test implementation unit 12 refers to the time of the extracted packet. If the packet data is not the data of the testing period (No at Step S303), the test implementation unit 12 ends the process.

If the time of the extracted packet is the packet data of the testing period (Yes at Step S303), the test implementation unit 12 determines whether the extracted packet is the packet to be sent to the server (Step S304).

If the packet is to be sent to the server (Yes at Step S304), the test implementation unit 12 sets the time (the time of the testing device) to the acquisition time of the packet (Step S305). After performing a process at Step S305, the test implementation unit 12 transmits the extracted packet to the post-operation server (Step S306). At this time, when changing information on the packet such as when using a different server after the operation, a part of the packet header or the like is rewritten and is transmitted.

When the packet has been transmitted at Step S306 or when the extracted packet is not to be sent to the server (No at Step S304), the test implementation unit 12 extracts the subsequent packet (Step S307) and repeats the process of Steps S303 to S307.

A process for periodically receiving the NTP time synchronization request messages from the post-operation server and performing the time synchronization on the post-operation server is performed in parallel with the above flow.

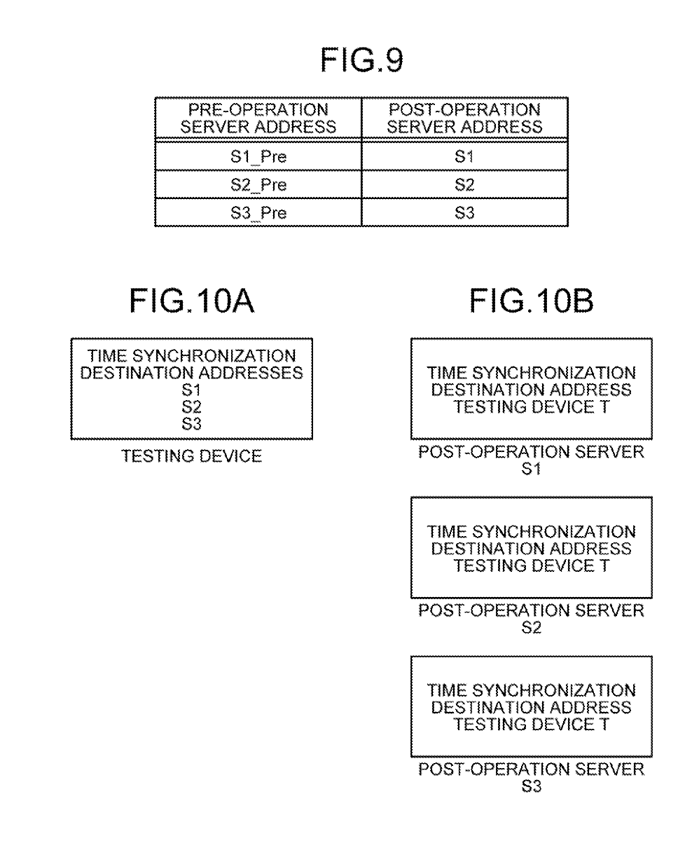

In the following, a description will be given of an example of the content in data of information on servers when a plurality of servers is used. FIG. 9 is a schematic diagram illustrating information used for managing the associated relationship between pre-operation servers and post-operation servers when a plurality of servers to be tested is arranged. As illustrated in FIG. 9, a pre-operation server address and a post-operation server address are managed as a pair. In FIG. 9, a case of a one-to-one address is illustrated as an example; however, there may also be a case of a many-to-one address when a test is performed by cutting down the number of post-operation servers. Furthermore, if an address is not changed before the operation and after the operation, the same address is used for the data before the operation and after the operation. By using this information, a transmission is performed by converting the transmission address to the address of the post-operation server.

In the example illustrated in FIG. 9, the address S1_Pre of the pre-operation server is associated with the address S1 of the post-operation server, the address S2_Pre of the pre-operation server is associated with the address S2 of the post-operation server, and the address S3_Pre of the pre-operation server is associated with the address S3 of the post-operation server.

FIGS. 10A and 10B are schematic diagrams illustrating information used for managing time synchronization targets. In an example of FIGS. 10A and 10B, the three post-operation servers of which the addresses are S1, S2, and S3 are prepared. In FIG. 10A, a case of performing a push-type time synchronization is illustrated. In the push-type time synchronization, the testing device manages the time synchronization destination addresses S1, S2, S3. In FIG. 10B, a case of performing the polling-type time synchronization is illustrated. In the polling-type time synchronization, each of the post-operation servers S1, S2, and S3 manages a time synchronization destination address and the address T of the testing device.

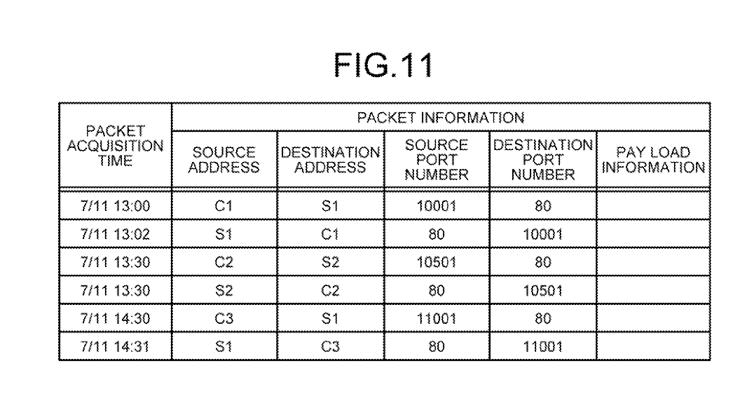

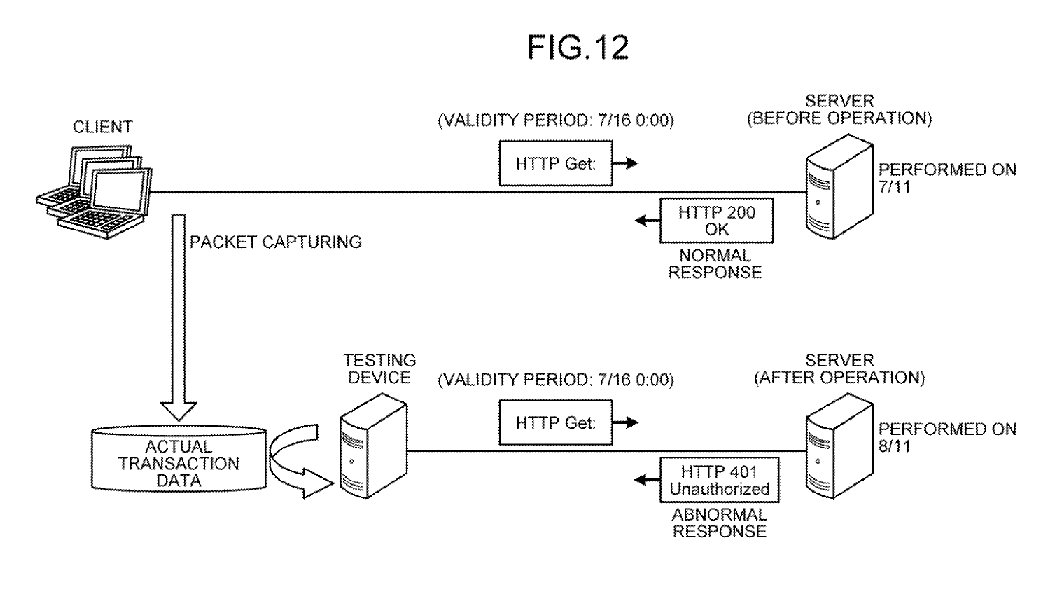

FIG. 11 is a schematic diagram illustrating packet capture information. As illustrated in FIG. 11, packet information is stored together with the packet acquisition time. As illustrated in FIG. 11, examples of the packet information includes, a source address, a destination address, a source port number, a destination port number, and pay load information; however, the information is not limited thereto. It is preferable to store all of the information included in the packet.

Specifically, in the example illustrated in FIG. 11, packets of the source address C1, the destination address S1, the source port number 10001, and the destination port number 80 are acquired at 13:00 on July 11. Packets of the source address S1, the destination address C1, the source port number 80, and the destination port number 10001 are acquired at 13:02 on July 11. Packets of the source address C2, the destination address S2, the source port number 10501, and the destination port number 80 are acquired at 13:30 on July 11. Packets of the source address S1, the destination address C1, the source port number 80, and the destination port number 10501 are acquired at 13:30 on July 11. Packets of the source address C3, the destination address S1, the source port number 11001, and the destination port number 80 are acquired at 14:30 on July 11. Packets of the source address S1, the destination address C3, the source port number 80, and the destination port number 11001 are acquired at 14:31 on July 11.

As described above, with the testing device, the testing method, and the testing program according to the embodiment, a test is performed by synchronizing the time of a target device with a time of packet collection times and then transmitting the collected packets to the target device in the order of the collection times.

Accordingly, an accurate accelerated test can be performed on transactions related to the time, such as the validity period. In particular, the number of time synchronizations and the schedule of the time synchronizations are optimized by using the duration of the validity period. Accordingly, it is possible to perform an accelerated test in which additional loads or the sequence are reduced as much as possible.

As described above, according to an aspect of the present invention, a test on a transaction related to the time, such as the validity period can be advantageously performed.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A testing device comprising:
a testing unit that transmits collected packets to a target device in order of collection times and obtains a response to the transmitted packets to perform a test; and
a synchronization control unit that synchronizes a time of the target device with a time of the packet collection times.

2. The testing device according to claim 1, wherein
the time of the target device is referred to by the target device when the response to the packets is performed, and
the response is performed on the basis of the time referred to by the target device.

3. The testing device according to claim 1, wherein the synchronization control unit performs the synchronization when a difference between the time at which the packets to be transmitted are collected and the time of the target device is equal to or greater than a predetermined range.

4. The testing device according to claim 1, wherein the synchronization control unit periodically performs the synchronization at predetermined time intervals.

5. The testing device according to claim 1, wherein, when address information obtained when the packets are collected is different from address information of the target device, the testing unit converts the obtained address information and transmits the packets to the target device.

6. The testing device according to claim 1, wherein the synchronization control unit performs synchronization on each of target devices.

7. A testing device comprising:
a processor; and
a storage unit that stores therein collected packets, wherein the processor executes:
synchronizing a time of a target device with a time of collection times of the collected packets;
transmitting the collected packets to the target device in order of the collection times; and
obtaining a response to the transmitted packets from the target device of which the time is synchronized.

8. A testing method comprising:
synchronizing a time of a target device with a time of collection times of collected packets;
transmitting the collected packets to the target device in order of the collection times; and
obtaining a response to the transmitted packets from the target device of which the time is synchronized.

9. A non-transitory computer readable storage medium that stores therein a testing program causing a computer to execute a process comprising:
synchronizing a time of a target device with a time of collection times of collected packets;
transmitting the collected packets to the target device in order of the collection times; and
obtaining a response to the transmitted packets from the target device of which the time is synchronized.
